(19) United States
(12) Patent Application Publication
(10) Pub. No.: US 2018/0345457 A1
(43) Pub. Date: Dec. 6, 2018

(54) Peening Method for Turbine Engine Component

(71) Applicant: Safran Aero Boosters SA, Herstal (BE)

(72) Inventor: Eric Englebert, Amay (BE)

(73) Assignee: SAFRAN AERO BOOSTERS SA, Herstal (BE)

(21) Appl. No.: 15/992,319

(22) Filed: May 30, 2018

(30) Foreign Application Priority Data
May 31, 2017 (BE) 2017/5389

(51) Int. Cl. B24C 1/10; F01D 5/14; F01D 5/28

(52) U.S. Cl. CPC B24C 1/10; F01D 5/147; F01D 5/28; F05D 2300/174; F05D 2240/24; F05D 2300/133; F05D 2230/90

(57) ABSTRACT

A method for manufacturing a component of an axial turbine engine includes the following steps: (a) providing or producing a component with a temporary surface; (b) placing the component in a chamber containing particles; and (c) vibratory peening of the temporary surface using the particles. The chamber includes an abrasive paste mixed with the particles so as to polish the surface of the component during the peening step (c). Thus, at the end of the peening step (c), the surface becomes a polished surface with a surface compression stress or prestress. The present application is notably applicable to a one-piece bladed drum of an aircraft turbojet engine low-pressure compressor.

This application claims priority under 35 U.S.C. § 119 to Belgium Patent Application No. 2017/5389, filed 31 May 2017, titled “Peening Method for Turbine Engine Component,” which is incorporated herein by reference for all purposes.

### BACKGROUND

### 1. Field of the Application

The present application relates to the surface treatment of a turbine engine component. More specifically, the present application is concerned with a method for peening (or shot-blasting) a component of a turbine engine, notably of an aircraft turbojet engine or of an aircraft turboprop engine.

### 2. Description of Related Art

Vibration fatigue-stresses turbine engine blades. During operation, cracks appear and spread from the exterior surfaces of the blades. The cracks can also be caused by a manufacturing method. In order to counter the spread of these cracks it is known practice to carry out a surface treatment using peening. This peening creates a compressive stress or prestress which has a tendency to close up a crack that might occur as soon as it begins.

Now, this peening marks the treated surfaces and increases the roughness thereof, and this slows the correct flow of the airstreams against these very surfaces. Polishing becomes necessary. Polishing facilitates flow on contact with the intrados surfaces and extrados surfaces of the blades. Thus, the throughput and efficiency of the turbine engine are improved.

Document US 2009235526 A1 discloses a method for producing a bladed drum for an axial turbine engine. The drum comprises a series of discs which are welded together and then undergo a heat treatment. The drum is peened. The surfaces obtained are smoothed using an abrasive paste. Polishing is performed in a tank containing the drum. This method makes it possible to create surfaces that meet high quality criteria, although they remain expensive to achieve.

Furthermore, there is still scope for improving the polishing, for example in relatively inaccessible regions. In addition, aeronautical components have only a limited number of surfaces via which they can be held for handling purposes during polishing, and this makes this operation all the more complicated. Their deformability and fragility govern the admissible loadings.

Although great strides have been made in the area of surface treatments to turbine engine components, many shortcomings remain.

### DESCRIPTION OF THE DRAWINGS

FIG. 1 depicts an axial turbine engine according to the present application.

FIG. 2 is a diagram of a peening chamber accommodating a turbine engine component according to the present application.

FIG. 3 illustrates a diagram of the method for manufacturing an axial turbine engine component according to the present application.

### DETAILED DESCRIPTION OF THE PREFERRED EMBODIMENT

The present application aims to at least partially solve one of the problems presented by the prior art. More specifically, it is an objective of the present application to improve the polishing of a turbine engine component. Another objective of the present application is to propose a solution that is robust, consistent, repeatable, easy to inspect, and that improves efficiency.

A subject of the present application is a method for manufacturing a component of an axial turbine engine, notably of an aircraft turbojet engine compressor, the method comprising the following steps: (a) providing or producing a component having a surface that is to be treated; (b) placing the component in a chamber containing particles; (c) vibratory peening of the surface using the particles; notable in that the chamber contains an abrasive paste mixed with the particles so as polish the peened surface during the peening step (c).

According to advantageous embodiments of the present application, the method may comprise one or more of the following features, considered in isolation or in any technically feasible combination:

The vibratory peening is ultrasonic peening or ultrasonic shot-blasting.

In the peening step (c), the roughness Ra of the peened surface becomes less than or equal to: 1.00 μm or 0.40 μm.

At the end of the peening step (c), the peened surface has a roughness Ra that varies locally by at most 20% with respect to the mean roughness of the said peened surface.

At the end of the peening step (c), the peened surface has a compression stress greater than or equal to: 100 MPa or to 800 MPa.

The compression stress added from the peening step (c) is present in a layer of a thickness less than or equal to: 1.00 mm, or 0.30 mm, or 0.10 mm.

During the peening step (c), the roughness Ra of the peened surface decreases at the same time as its compression stress increases.

The peened surface is made of titanium or titanium alloy.

The particles are balls.

The abrasive paste is a fluid abrasive paste.

During the peening step (c), the abrasive paste removes material from the peened surface of the component.

The particles and the abrasive paste form a homogeneous mixture on contact with the peened surface during the peening step (c).

The component is/or comprises an annular wall intended to guide an annular stream through the turbine engine, the annular wall potentially being a turbine engine casing wall such as a nozzle.

The component is/or comprises a turbine engine blade, the peened surface potentially forming an intrados surface and an extrados surface of the blade.

The component is/or comprises a disc with a rim and an annular row of blades distributed about the disc, the rim and the said blades forming a one-piece assembly.

The component is/or comprises a drum with an annular web and several annular rows of blades distributed around the annular web, the annular rows being distributed axially along the annular web and forming, with the said annular web, a one-piece assembly.

The or each blade comprises a fillet radius, the roughness of which decreases during the peening step (c).

The blade comprises a leading edge and a trailing edge, the fillet radius extending from the leading edge to the trailing edge of the blade.

The component has a central cavity exhibiting a main direction of increase in width and during the peening step (c), the component is oriented with its main direction of increase in width upwards.

In the providing or producing step (a), the surface is a temporary or unfinished surface and at the end of the peening step (c), the surface becomes a definite surface of the component.

The method further comprises a step (d) of dynamic balancing of the component, taking into account the change in mass of the component at its peened surface.

During the peening step (c), the compressive mechanical stress in the surface increases.

The stress is a surface compressive prestress.

The surface comprises a fillet radius, the roughness Ra of which decreases during the peening step (c).

The component is a turbine engine compressor component, potentially a low-pressure compressor.

The turbine engine is an aircraft turbojet engine.

The web exhibits a direction of overall increase in diameter and during the peening step (c) the drum is oriented with its direction of overall increase in diameter upwards.

The component is configured to rotate at a rotational speed greater than or equal to: 4000 rpm, of 10 000 rpm, or 18 000 rpm.

The component comprises a one-piece bladed disc.

The component comprises a one-piece bladed drum.

The blade comprises a base and/or a support for attaching to a guide surface that guides an annular airstream of the turbine engine, the said blade extending perpendicular to the said surface.

During the peening step (c), the frequency of vibration of the particles is greater than or equal to 10 kHz or 20 kHz.

During the peening step (c), the mean amplitude of displacement of the particles is less than or equal to: 5 mm, or 1 mm, or 0.1 mm.

The component has a thickness, the surface comprising a concave surface and a convex surface which is on the opposite to the concave surface about the thickness of the said component, the said surfaces being peened and polished simultaneously during the peening step (c).

At least one or each annular row of drum or disc blades comprises at least: fifty, or eighty, or one hundred blades.

The annular wall supports at least one or several annular rows of blades.

The turbine engine aspect is not an essential aspect of the present application. The present application also covers a method for manufacturing a component, the method comprising the following steps: (a) providing or producing a component having a surface, (b) placing the component in a chamber containing particles; (c) vibratory peening of the temporary surface using the particles; noteworthy in that the chamber contains an abrasive material, potentially in the form of a paste, mixed with the particles so as polish the surface of the component during the peening step (c).

The features set out in relation to each blade may be applied to blades on a disc, to blades on a drum, to blades on an annular wall.

In general, the advantageous embodiments of each subject matter of the present application can also be applied to the other subject matters of the present application. Each subject matter of the present application can be combined with the other subject matters and the subject matters of the present application can also be combined with the embodiments of the description, which in addition can be combined with one another, in any technically feasible combination, unless explicitly specified to the contrary.

The present application homogeneously improves the surface treatment. Specifically, the particles carry and apply the abrasive means to the smallest corners that are to be treated, whatever the accessibility and visibility of these corners. The particle impact phenomenon improves the effectiveness of the abrasive material.

In the context of a bladed wheel, the polishing of the faces of the blades just like the fillet radii remains of high quality despite the presence of stumps or blades which form masks and obstacles that need to be circumvented. The benefit remains constant even in the presence of other rows of blades in the vicinity of the surfaces that are to be treated, such as in the case of a one-piece bladed drum.

In the providing or producing step (a), the surface is a temporary or unfinished surface, and at the end of the peening step (c), the surface becomes a definitive surface of the component. The internal stress, the geometry and the mirror polished surface finish can be used directly in a turbine engine, and potentially conform to aeronautical safety standards.

In the description which follows, the terms “internal” and “external” refer to positioning with respect to the axis of rotation of an axial turbine engine. The axial direction corresponds to the direction along the axis of rotation of the turbine engine. The radial direction is perpendicular to the axis of rotation.

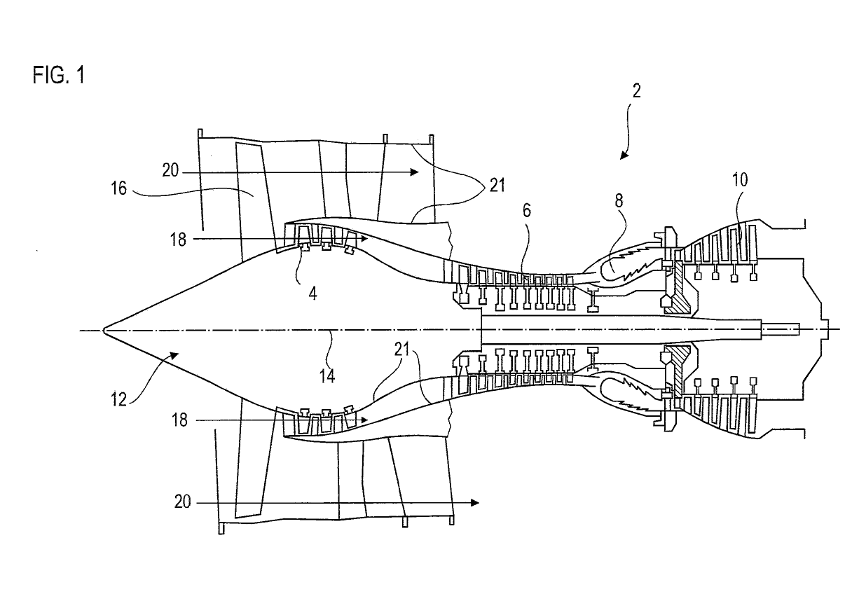

FIG. 1 is a simplified depiction of an axial turbine engine. In this particular instance it is a bypass turbojet engine. The turbojet engine 2 comprises a first compression stage, referred to as the low-pressure compressor 4, a second compression stage, referred to as the high-pressure compressor 6, a combustion chamber 8 and one or more turbine stages 10. In operation, the mechanical power of the turbine 10, transmitted via the central shaft to the rotor 12, drives the movement of the two compressors 4 and 6. These comprise several rows of rotor blades associated with rows of stator blades. Rotation of the rotor about its axis of rotation 14 thus makes it possible to generate an airflow and to compress the latter progressively until it enters the combustion chamber 8.

An inlet blower commonly referred to as a fan 16 is coupled to the rotor 12 and generates an airstream which splits into a primary stream 18 passing through the various aforementioned turbine engine stages, and a secondary or bypass stream 20 that passes through an annular duct (partially depicted) along the machine to then recombine with the primary stream at the outlet of the turbine. The fan typically comprises a circular cascade of blades, possibly from twenty to thirty blades.

The secondary stream may be accelerated in such a way as to generate a thrust reaction necessary for the flight of an aircraft. The primary 18 and bypass 20 streams are coaxial annular streams one inside the other. They are ducted by the turbine engine casing. To this end, the casing has annular walls 21 which may be internal and external.

An annular wall 21 may delimit the primary flow path through which the primary stream 18 passes. An annular wall 21 may connect the low-pressure compressor 4 to the high-pressure compressor 6, or the latter to the combustion chamber 8. The annular walls 21 may form a nozzle or an annular nozzle ducting the primary stream 18 or the bypass stream 20.

In the low-pressure compressor 4, the rotor 12 comprises several rows of rotor blades, for example three rows. The rotor 12 may comprise a bladed disc and/or a bladed drum. The disc just like the drum may be one-piece. What that means to say is that the blades and their disc, or the blades and their drum, form the one same solid.

The low-pressure compressor 4 comprises several sets of guide vanes, potentially four sets, each containing a row of stator blades. The guide vanes are associated with the fan 16 or with a row of rotor blades to straighten the airstream so as to convert the speed of the stream into a pressure, notably a static pressure. The rows of rotor blades and of stator blades are positioned axially in alternation with each other.

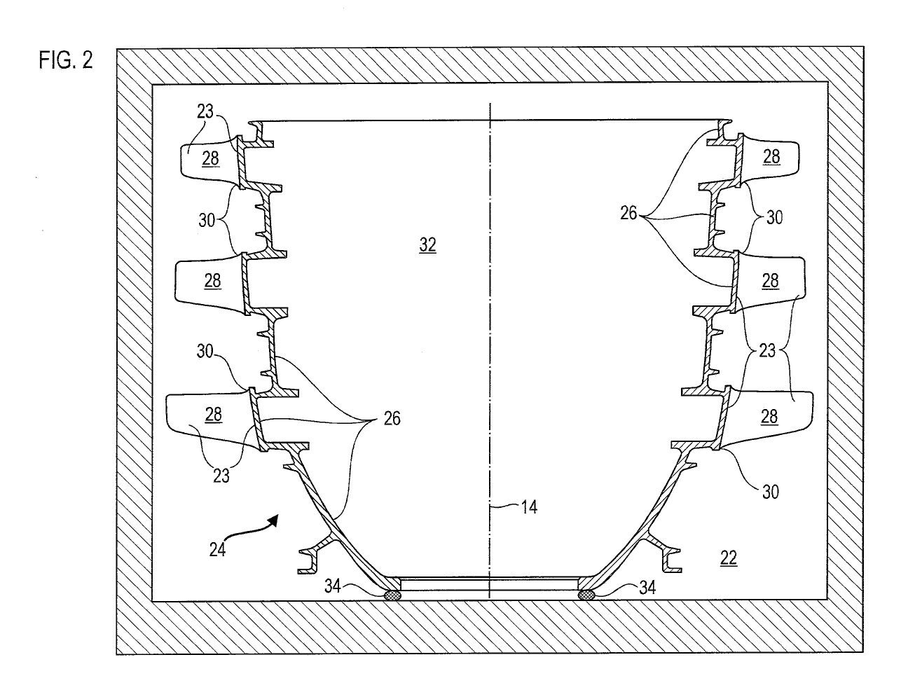

FIG. 2 depicts a chamber 22 of an ultrasonic peening machine. The machine comprises an ultrasound source (not depicted) exciting the vibration of the particles (not depicted), the movements of which allow peening as they impact on the surface of a component that is to be treated. The particles, or shot, have a hardness higher than that of the peened surface 23 of the component.

According to the present application, an abrasive paste is mixed with the particles, notably homogeneously, so that polishing takes place at the same time as peening. The particles may be balls. The abrasive paste may be fluid. It may coat the particles so that they polish the surface at the same time as they are work-hardening it.

The peening chamber 22 accommodates a component, in this instance a one-piece bladed drum 24, which experiences a surface treatment by, ultrasonic peening. The drum 24 may correspond to the one shown in relation to FIG. 1. In addition, such a chamber 22 may also accommodate a blade, a bladed disc, an annular wall, such as those described in connection with FIG. 1.

The drum 24 exhibits an annular web 26 supporting several annular rows of rotor blades 28. These rows are distributed axially along the axis of rotation 14 of the drum 24. Moreover, the blades 28, notably the exterior surfaces thereof, exhibit fillet radii 30 where they meet the annular web 26. These fillet radii 30 form corners, access to which is limited by the blades 28 themselves. The radial height and close spacing of the blades 28 heighten the complexity.

The intrados surface and the extrados surface of the blade 28 may form the peened surface 23 of the component. This peened surface may also be formed on the web 26, notably from where the blades 28 extend. Thus, the peened surface 23 may be locally annular.

Each fillet radius 30 may surround the corresponding blade 28. It may run along the intrados surface and the extrados surface of the associated blade 28. It may begin at the annular web 26 and/or connect the leading edge to the trailing edge of the blade 28, on both faces thereof. Upon peening, the roughness Ra of the fillet radii 30 may decrease, notably over the entire length thereof. The roughness of the fillet radii 30 may be homogeneous from a leading edge to the trailing edge despite the slenderness of the component at these edges.

A bladed disc, or blisk (not depicted) may comprise a single row of blades 28, it may be likened to the drum in as much as its rim forms an axial portion of annular web 26 bearing the said blades 28.

The component may comprise a main cavity, or central cavity 32. During peening, the mixture of particles and abrasive paste may be in the chamber 22, and outside of the component. The mixture may be outside of the cavity 32. A seal 34 may be positioned at an axial end of the component in order to hold back the mixture.

The component, notably the cavity 32 thereof, exhibits a reduction in overall width or overall diameter. During its surface treatment, its reduction in width, or least width, may be positioned downward.

The component, and therefore the peened surface or surfaces 23 thereof, may be made of titanium or titanium alloy, potentially in full. It may be of the Ti6Al4V type. Other materials are conceivable.

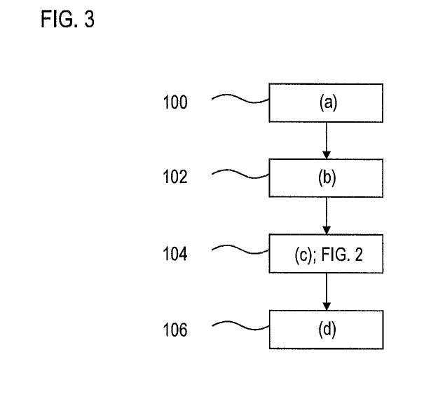

FIG. 3 is a diagram of the method for manufacturing a turbine engine component. The corresponding component may be one of those mentioned in connection with one of FIGS. 1 and 2; therefore: a blade, an annular wall, a bladed disc, a bladed drum.

The method may comprise the following steps, notably performed in the following order:

providing or producing 100 a component, possibly an unfinished or rough-form of component, having a temporary surface that is to be treated,

placing 102 the component in a chamber containing particles, the surface that is to be treated being in contact with the particles;

ultrasonic peening 104 of the temporary surface using the particles mixed with an abrasive paste;

dynamic balancing 106 of the component, when this is a rotor component, such as a turbine engine disc or drum. This step is optional in the context of the present application.

During the producing or creating 100 step (a), the component may be produced by additive manufacturing using powder-based layers. A drum or a disc may be produced by machining a pre-forged casting. The blades may be welded straight onto an annular web or a rim. The welding may be friction welding or electron welding. The component may potentially be machined from solid and/or produced by casting.

During the placing 102 step (b), the component is introduced into the chamber and then potentially buried in the particles/paste mixture. This mixture may be tipped into the chamber so that it comes into contact with the surface that is to be treated of the component. Only the outside of the component may be in contact with the mixture, its cavity may remain empty of mixture.

FIG. 2 may be indicative of the peening 104 step (c).

During the peening step (c), the roughness Ra of the surface may become at most: 3.2 microns or 1.60 μm, or 0.4 μm, or 0.20 μm. In addition, the result is homogeneous because at the end of the peening step (c) the peened surface exhibits a roughness Ra locally varying by at most: 50%, or 35%, or 20%, 10%, or 5%, with respect to the mean roughness of the said peened surface. The roughness is eroded away, giving way to a treated surface that is particularly smooth to facilitate the flow of a turbojet engine transonic fluid.

In parallel with the polishing, the application of compression to the surface takes place potentially continuously. At the end of the peening 102 step (c), the surface exhibits a compression stress greater than or equal to: 50 MPa, or 100 MPa, or 800 MPa, or 1000 MPa. Also, the compressive stress remains a surface stress. It is produced on the peened surface at a depth less than or equal to 1.00 mm, or 0.30 mm or 0.10 mm.

The criterion pertaining to the homogeneity of the roughness may be applied to the homogeneity of the compressive stress.

The dynamic balancing 106 step (d) corrects and takes into consideration the change in the mass of the component at the peened surface thereof. This may involve looking for and correcting imbalance in a rotor component, such as the bladed disc or the bladed drum exhibits. In the dynamic balancing 106 step (d), the compressive stress remains present.

The method may also comprise a heat treatment and/or a chemical treatment of the peened surface.

I claim:

1. Method for manufacturing a component of an axial turbine engine, the method comprising:
(a) providing or producing a component having a surface that is to be treated;
(b) placing the component in a chamber containing particles; and
(c) vibratory peening of the surface using the particles;
wherein the chamber contains an abrasive paste mixed with the particles so as to polish the peened surface during the peening step (c).

2. Method according to claim 1, wherein in the peening step (c), the roughness Ra of the peened surface becomes less than or equal to: 1.00 μm or 0.40 μm.

3. Method according to claim 1, wherein, at the end of the peening step (c), the peened surface has a roughness Ra that varies locally by at most 20% with respect to the mean roughness of the said peened surface.

4. Method according to claim 1, wherein, at the end of the peening step (c), the peened surface has a compression stress greater than or equal to: 100 MPa or to 800 MPa.

5. Method according to claim 4, wherein the compression stress added from the peening step (c) is present in a layer of a thickness less than or equal to: 1.00 mm, or 0.30 mm, or 0.10 mm.

6. Method according to claim 1, wherein, during the peening step (c), the roughness Ra of the peened surface decreases at the same time as its compression stress increases.

7. Method according to claim 1, wherein the peened surface is made of titanium or titanium alloy.

8. Method according to claim 1, wherein the particles are balls.

9. Method according to claim 1, wherein the abrasive paste is a fluid abrasive paste.

10. Method according to claim 1, wherein during the peening step (c), the abrasive paste removes material from the peened surface of the component.

11. Method according to claim 1, wherein the particles and the abrasive paste form a homogeneous mixture on contact with the peened surface during the peening step (c).

12. Method according to claim 1, wherein the component comprises:
an annular wall intended to guide an annular stream through the turbine engine, the annular wall potentially being a turbine engine casing wall such as a nozzle.

13. Method according to claim 1, wherein the component comprises:
a turbine engine blade, the peened surface potentially forming an intrados surface and an extrados surface of the blade.

14. Method according to claim 1, wherein the component comprises:
a disc with a rim and an annular row of blades distributed about the disc, the rim and the said blades forming a one-piece assembly.

15. Method according to claim 1, wherein the component comprises:
a drum with an annular web and several annular rows of blades distributed around the annular web, the annular rows being distributed axially along the annular web and forming, with the said annular web, a one-piece assembly.

16. Method according to claim 1, wherein the component comprises:
a turbine engine blade, the or each blade comprises a fillet radius, the roughness of which decreases during the peening step (c).

17. Method according to claim 16, wherein the blade comprises:
a leading edge and a trailing edge, the fillet radius extending from the leading edge to the trailing edge of the blade.

18. Method according to claim 1, wherein the component has a central cavity exhibiting a main direction of increase in width and during the peening step (c), the component is oriented with its main direction of increase in width upwards.

19. Method according to claim 1, wherein in the providing or producing step (a), the surface is a temporary or unfinished surface and at the end of the peening step (c), the surface becomes a definite surface of the component.

20. Method according to claim 1, further comprising:
(d) dynamic balancing of the component, taking into account the change in mass of the component at its peened surface.

21. Method for manufacturing a turbine engine compressor component, the method comprising:
providing or producing a component having a surface that is to be treated;
placing the component in a chamber containing particles; and
ultrasonic peening of the surface using the particles;
wherein the chamber contains an abrasive paste mixed with the particles so as to polish the peened surface during the peening step (c).

22. Method for manufacturing a component of an axial turbine engine, the method comprising:
providing or producing a component having a surface that is to be treated;
placing the component in a chamber containing particles; and
vibratory peening of the surface using the particles;
wherein the chamber contains an abrasive paste mixed with the particles so as to polish the peened surface during the peening step (c); and
wherein during the peening step (c), the roughness Ra of the peened surface decreases at the same time as its compression stress increases.
